(19) United States
(12) Patent Application Publication
(10) Pub. No.: US 2015/0310482 A1
(43) Pub. Date: Oct. 29, 2015

(54) METHOD AND SURVEY SERVER FOR GENERATING METRICS INDICATIVE OF WEBSITE VISIT ORIGINATING CHANNEL EFFECTIVENEESS

(71) Applicant: IPERCEPTIONS INC., Montreal (CA)

(72) Inventors: Matthew Butler, Montreal (CA); Lane Cochrane, Kirkland (CA)

(21) Appl. No.: 14/693,941

(22) Filed: Apr. 23, 2015

Related U.S. Application Data
(60) Provisional application No. 61/983,093, filed on Apr. 23, 2014.

(51) Int. Cl. G06Q 30/02

(52) U.S. Cl. CPC G06Q 30/0245

(57) ABSTRACT

Method and survey server for correlating originating channels of a website visit with corresponding survey participation data. The server collects website visit data from a plurality of user devices. The website visit data comprise for each user device an originating channel that led to a visit of the website by a user of the user device. The server collects survey participation data from some of the user devices. The survey participation data correspond to survey information received from the users of the user devices in relation to the visit of the website. The server analyzes the website visit data and the survey participation data, to generate metrics correlating the originating channels of the website visit data with the survey participation data. The originating channels may comprise a direct access to the visited website, a referrer hyperlink to the visited website, and a search result leading to the visited website.

### TECHNICAL FIELD

The present disclosure relates to the field of website evaluation, and more precisely to a method and survey server for correlating originating channels of a website visit with corresponding survey participation data.

### BACKGROUND

Nowadays, it is very important for corporations to understand the potential intent of website visitors in relation with their brand, services and products. Inaccurate identification of website visitors' intents may result in great losses, for instance loss of sales, inaccurate responses to the needs of the visitors, loss of fidelity to the brand, etc. Accordingly, any tool to increase the corporate understanding of website visitors, and the validity level associable to this knowledge, has important value for corporations

The same applies to tools used to interact with website visitors. The more efficient they are, the more efficient the processes to monetize the interactions with these website visitors will be. Accordingly, evaluation tools are necessary to establish the efficiency of the tools used to interact with the website visitors, including tools used to evaluate websites.

Currently the most commonly used tools to acquire this kind of information (e.g. understanding the level of success of a website) can be divided in the following categories: (1) web analytics tools such as Google Analytics™, (2) survey tools, and (3) session recording tools, also known as session replay processes. While the first category of tools follow actions performed by website visitors (responding to the WHAT question), it fails to determine the reasons why a website visitors did not complete a task (the WHY question), such as not completing a purchase. The second category of tools is effective at determining the reasons for a website visitor not having completed a task, but lacks to provide perspective on the basis for the opinions provided by the website visitor in his answers to a survey (e.g. fails to provide any hint of a solution to correct the situation). The third category of tools collects the actions of a website visitor, but is only based on actions performed by the website visitor during the website visit.

Available tools (alone or in combination) fail to provide a solution for correlating indications customers dissatisfaction of their visit of a website, with the channel that led them to visiting the website.

Therefore, there is a need for a method and survey server for correlating originating channels of a website visit with corresponding survey participation data.

### SUMMARY

According to a first aspect, the present disclosure provides a survey server. The survey server comprises a processing unit, a communication interface for exchanging data with a plurality of user devices, and memory. The memory stores website visit data and survey participation data. The memory further stores code responsible, when executed by the processing unit, for collecting the website visit data from the plurality of user devices. The website visit data comprise for each specific user device an originating channel that led to a visit of the website by a user of the specific user device. The code is also responsible for collecting the survey participation data from some of the plurality of user devices. The survey participation data correspond to survey information received from the users of the user devices in relation to the visit of the website. The code is further responsible for analyzing the website visit data and the survey participation data, to generate metrics correlating the originating channels of the website visit data with the survey participation data.

According to a second aspect, the present disclosure provides a method for correlating originating channels of a website visit with corresponding survey participation data. The method comprises collecting, at a survey server, website visit data from a plurality of user devices. The website visit data comprise for each specific user device an originating channel that led to a visit of the website by a user of the specific user device. The method also comprises collecting, at the survey server, survey participation data from some of the plurality of user devices. The survey participation data correspond to survey information received from the users of the user devices in relation to the visit of the website. The method further comprises analyzing, by the survey server, the website visit data and the survey participation data to generate metrics correlating the originating channels of the website visit data with the survey participation data.

### BRIEF DESCRIPTION OF THE DRAWINGS

Embodiments of the disclosure will be described by way of example only with reference to the accompanying drawings, in which:

FIG. 1 is an exemplary schematic illustration of a survey server in communication with user devices over the Internet;

FIG. 2a is an exemplary schematic illustration of the user device of FIG. 1 hosting a web client;

FIG. 2b is an exemplary schematic functional illustration of the web client of FIG. 2a;

FIG. 3 is an exemplary flow chart illustrating steps performed by the user device of FIGS. 1 and 2a;

FIG. 4 is an exemplary flow chart illustrating steps performed by the survey server of FIG. 1;

FIG. 5 is an exemplary illustration of a table comprising website visit data collected by the survey server of FIG. 1; and

FIG. 6 is an exemplary illustration of a table comprising survey participation data collected by the survey server of FIG. 1.

### DETAILED DESCRIPTION

The foregoing and other features will become more apparent upon reading of the following non-restrictive description of illustrative embodiments thereof, given by way of example only with reference to the accompanying drawings.

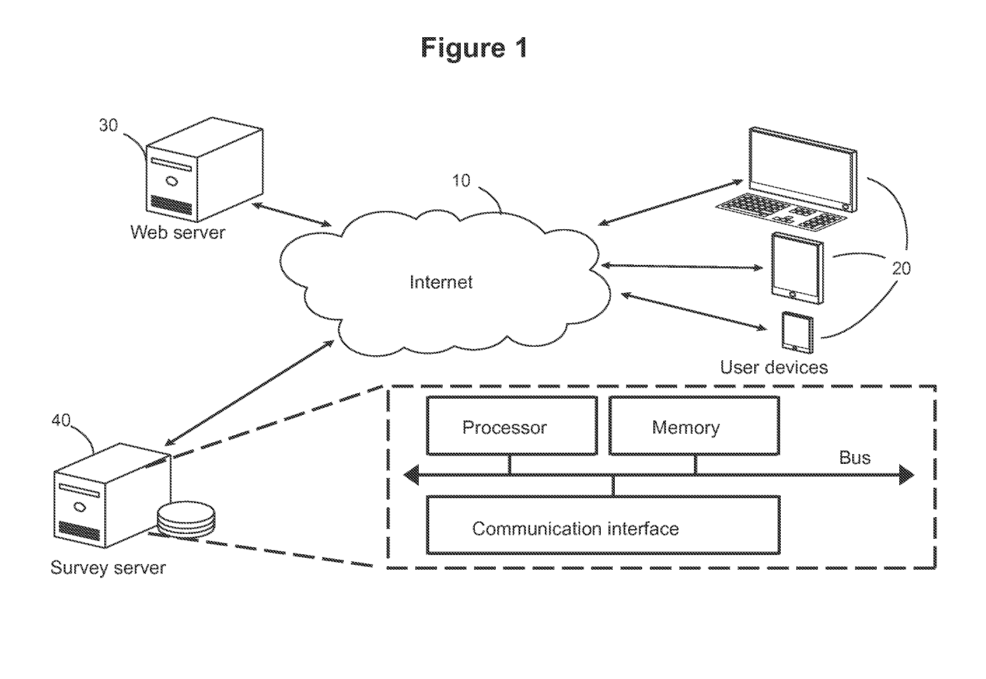

Referring now to FIG. 1, a transaction-based environment (such as an electronic commerce environment) is represented. This environment involves in combination processor-based devices such as a user device 20 hosting a web client (for instance a web browser), a web server 30, and a survey server 40. The different devices which participate in the process are in communication over a communication network, such as the Internet 10 or a plurality of networks linked or bridged electronically, optically or wirelessly and permitting communication between the different devices.

For the purpose of the present disclosure, a method and survey server for correlating originating channels of a website visit with corresponding survey participation data will be depicted in relation with the above-described environment. One must understand that this environment is for illustration purposes only. It is not intended to limit the scope of the present method and survey server. Furthermore, optional devices (not illustrated in the Figures) may also participate in the above-described environment. Examples of optional devices include a web analytic server and a tag management server.

The term web server is given its usual definition (which is well known in the art), namely a processor-based device responding to website visit requests, and transmitting HyperText Markup Language (HTML) documents and optionally other web content to requesting devices over a network such as the Internet. The nature of the web content transmitted may consist of the complete data necessary to provide a desired display interface, such as a webpage; or partial content of an interface, the remaining part depending on processing of locally-stored data.

Similarly, the term server is given its usual definition (which is well known in the art), namely a processor-based device in communication with other devices over a network such as the Internet, and able to perform specialized tasks based on an exchange of information with the other devices via the network.

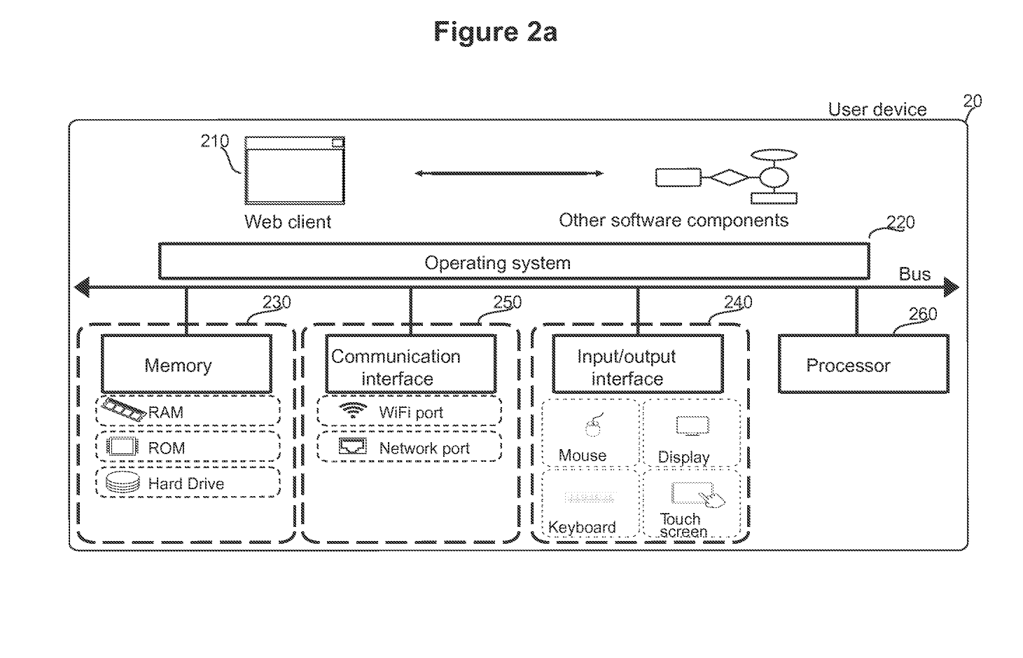

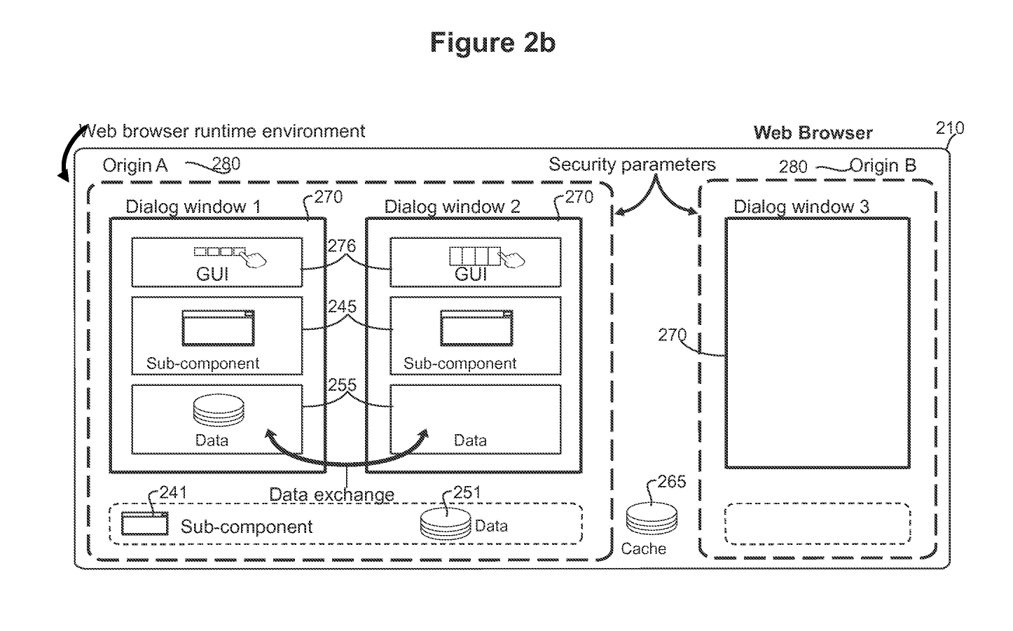

Reference is now made concurrently to FIGS. 1 and 2a. FIG. 2a illustrates an example of a generic-purpose user device 20 hosting a web client 210. The user device 20 comprises hardware components and software components. The software components are generated when a user device processing unit 260 processes codes or instructions stored on memory 230 associated therewith. As illustrated, the web client 210 is hosted by the user device 20. The web client 210 is a software component which may either be manufactured with the user device 20, or the web client 210 may be installed later. The web client 210 may consist in a web browser such as Microsoft Internet Explorer™, Google Chrome™, Apple Safari™, Mozilla Firefox™, etc. Other web clients 210 customized for specific tasks and/or processes and designed to communicate with specific servers, may be available such as those developed under the Adobe Integrated Runtime (AIR) or Windows Runtime (WinRT) environment. The user device 20 may also include other software components. The web client 210 and the other software components are supported by an operating system 220. The user device 20 further comprises the following hardware components (as illustrated in FIG. 2a): the processing unit 260, the memory 230, an input/output interface 240, and a communication interface 250 for communicating over a network. The processing unit 260 may comprise one or several processors, each processor including one or several cores. The web client 210 is designed to interact with the hardware components in a functional manner through the operating system 220, for instance to access memory 230 for reading and writing purposes, to communicate with remote processor-based devices via the communication interface 250, to display information, and to receive input from a user via the input/output interface 240 (for instance through keyboard and mouse controls, etc.).

The web client 210 (e.g. a web browser) is able to access a variety of websites via one or more different channels of access, which are evaluated by the method and survey server of the present disclosure. For instance, the channels through which a particular website is accessed include access via manual entry of the Uniform Resource Locator (URL) of the particular website in the web client 210, activation of a hyperlink leading to the particular website, etc. The nature of the hyperlink may also vary greatly.

Reference is now made concurrently to FIGS. 1, 2a and 2b. The web client 210 represented in FIG. 2b is a web browser designed to access a website by exchanging data packets with a web server 30; and downloading and processing web content, such as HTML documents, transmitted by the web server 30. Thus, the web browser 210 provides access to webpages of the website hosted by the web server 30 to the user of the device 20.

The web browser 210 is further adapted to provide the necessary runtime environment for software sub-components to be generated when HTML documents featuring embedded instructions (also called scripts) are received. The web browser 210 is also adapted to apply security policies in relation with the provided runtime environment. For instance, the security policies limit accessibility of information and processes according to origin identification, therefore isolating data relative to a dialog window with respect to one origin from another dialog window (and associated processes) with respect to another origin.

The web browser 210 is further designed to store in memory 230 codes to be run according to runtime environment policies, such as scripts and cookies. In relation with the graphical user interface provided by the web browser 210, one or more dialog windows 270 may be present per origin identifier 280. The security policies and runtime environment provided by the web browser 210 permit to store data in association with dialog windows 270 (e.g. data 255) or with origin identifier 280 (e.g. data 251). They also permit data exchanges between the data 251 and 255, or between data 255 corresponding to different dialog windows 270 (e.g. dialog window 1 and dialog window 2 in FIG. 2b).

The security policies and runtime environment provided by the web browser 210 generate sub-components 241 and 245 associated with either the dialog windows 270 or the origin identifier 280. Such logic components 241 and 245 include sub-components generated based on received web content (e.g. scripts).

The dialog windows 270 may either or not be part of the same browsing session, based on the web domain the dialog windows 270 are in communication with. As illustrated, the origin identifier 280 (e.g. origin A and origin B in FIG. 2b) establishes a security parameter for isolating information (e.g. 251 and 255), sub-components (e.g. 241 and 245), and resulting processes, from one browsing session with respect to another browsing session, The isolation is based on the origin identifier 280, rather than on a graphical presentation in the graphical interface of the web client 210.

The web browser 210 further comprises a cache 265 that may be used to store web content. When a website visit request is performed, the web browser 210 may retrieve from the cache 265 some or all of the web content collected during a previous web session, which has been stored in the cache 265 earlier. The object of the cache 265 is to accelerate webpage generation and display, by decreasing the needs of data exchange between the web browser 210 and the web server 30.

The processing unit 260 executes instructions of the web browser 210. During the executions of the instructions of the web browser 210, the processing unit 260 accesses memory 230, uses the communication interface 250 to send and receive data packets, relies on the input/output interface 240 to obtain inputs from the user, displays webpages on a display of the user device 20, etc. Upon visiting of a website, the web content received from the corresponding web server 30 to generate and display webpages includes at least one of: 1) HTML documents, 2) Content Style Sheets (CSS) capable of providing display layouts and rules used to determine the layout for generating a webpage to be displayed, and 3) discrete web content to be integrated in the displayed webpage independently from a webpage structure provided by the HTML document and the Content Style Sheet. Examples of discrete web contents include text elements, images, sounds, videos, animations, etc. According to this definition, website visit content generally includes at least one HTML document, and may include a Content Style Sheet and zero to multiple discrete web contents to be integrated in the webpage(s) to be displayed.

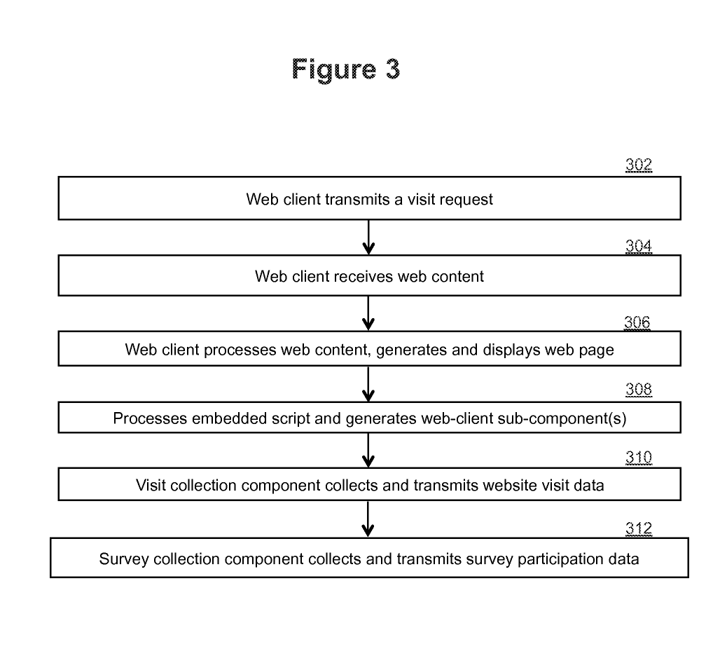

Reference is now made concurrently to FIGS. 1, 2a, 2b, 3, 5 and 6, where FIG. 3 illustrates steps performed on the user device 20 for correlating originating channels of a website visit with corresponding survey participation data.

At step 302, the web client 210 transmits a visit request to a web server 30 to visit a website hosted by the web server 30. The visit request is based on an identification of the website by an URL of the website. The visit request may result from a variety of actions performed by the user of the user device 20 prior to the present step 302, each particular action defining an originating channel for accessing the website.

A first example of action consists in the user of the user device 20 manually entering, or alternatively selecting, the URL of the website. The URL selection may consist in selecting a file, a bookmark, an entry in the browsing history of the web client 210, etc. Based on the entered URL or the selected bookmark for instance, the web client 210 generates and transmits the website visit request. An originating channel corresponding to this first example will be referred to as a direct access to the visited website in the rest of the disclosure.

A second example of action consists in following the user of the user device 20 performing a search via an Internet search engine (e.g. Google search engine). Based on the search query, the search engine provides a series of search results to the user, and optionally advertising content (e.g. from Google AdWords™) associated to the search results. The advertising content is displayed as hyperlinks. If the user activates an advertising content by clicking on the corresponding hyperlink, a visit request is transmitted to a web server hosting the website associated to the hyperlink. The visit request transmitted to the web server includes information indicating that the visit request originates from an identified search engine, and optionally information on the nature of the search query performed by the user to obtain the visit-leading search result (e.g. keywords used for the search query).

A third example of action consists in the user of the user device 20 activating (e.g. by clicking on) a hyperlink to a destination website when visiting a referrer website. Accordingly, the web server receiving the visit request to the destination website also receives information on the origin (the referrer website) of the visit request, as well as the nature of the action that led to the visit (e.g. clicking on the hyperlink).

The three previous examples are for illustration purposes only, and are not intended to limit the types of originating channel which can be used by the user of the user device 20 for accessing a particular website. However, for each specific originating channel, information related to the specific originating channel used are transmitted in the visit request for visiting the particular website.

At step 304, the web client 210 receives web content in response to the visit request sent at step 302. The web content includes all the data to be processed by the processing unit 260 of the user device 20, according to the provided runtime environment of the web client 210, to provide the visitor with a webpage.

At step 306, the web client 210 processes the web content received at step 304, and generates the corresponding webpage. It further displays the webpage to the website visitor.

At step 308, the web client 210 identifies and processes script(s) or other processing codes embedded in the web content, according to the runtime environment provided by the web client 210. It thereby generates sub-components of the web client 210, which perform tasks in accordance with the limits imposed by the web client 210 with respect to the origin identifier associated with the website. These sub-components include a visit collection component and a survey collection component.

At step 310, the visit collection component collects website visit data related to the current web session (which may be partially stored in the memory 230), including the originating channel of the website visit, and complementary information related to the channel if available (such as the previously mentioned search keywords). The visit collection component transmits the collected website visit data to the survey server 40. The data transmitted include a web session identifier. The data transmitted also include a website identifier (e.g. URL of the website). This step performed by the visit collection component is generally invisible to the website visitor, taking place in the background with data exchanges occurring between the web client 210 and the survey server 40.

Additional website visit data may be collected by the visit collection component at step 310, and transmitted to the survey server 40.

The additional data may include a type of device on which the visit collection component runs. The type of device can be automatically collected by a web client 210, as is well known in the art. For instance, the type of device consists in one of the following: a desktop or a laptop computer, a tablet, and a smartphone.

The additional data may further include a source of the website visit. Examples of sources include one of the following: a receipt, a Content Management System (CMS)/a Customer Relation Management (CRM) system, a mobile website, a Quick Response (QR) Code, a Short Message Service (SMS), a social media, an email campaign, a video game, an off-line activity, a link, a navigation system, etc.

The additional data may further include a channel category based on Google Analytics™. Examples of channel categories include one of the following: direct, generic organic search, generic paid search, referral, email, other advertising, social, and display.

The additional data may include search keyword(s) used in a search query leading to the website visit, including paid and unpaid keywords.

The additional data may include a landing page URL (the URL of the particular webpage of the visited website to which the originating channel leads).

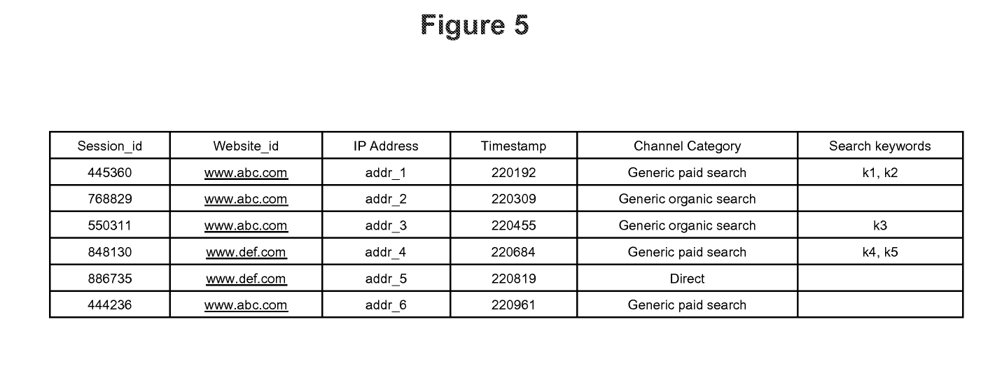

FIG. 5 illustrates an example of a table which can be generated and stored by the survey server 40, based on the data transmitted by the visit collection component at step 310. This table is for illustration purposes only, and is not intended to limit the type of data collected and transmitted by the visit collection component. The table contains the aforementioned web session identifier (Session_id), which may consist of a generated unique number. The table contains an identifier of the visited website (Website_id), which generally consists in the URL of the website. The table contains an identifier of the user device 20, such as its IP address. The table contains a timestamp, to identify the time at which the data have been collected. The table contains the aforementioned channel category based on Google Analytics™. The table contains search keyword(s) when the originating channel is a search engine, and the search keyword(s) are available.

At step 312, the survey collection component collects responses to a web survey from the website visitor, including response(s) with respect to his intent for visiting the website. The survey collection component generates survey participation data based on the responses to the survey, and transmits the survey participation data to the survey server 40. Step 312 may take place at the beginning of the website visit, at the end of the website visit, or sometimes during the website visit. Step 312 may be initiated by the user. For instance, when a survey questionnaire is associated with an icon appearing on one or more webpages of the website, the visitor clicks on the icon to initiate the survey process. Alternatively, the survey collection component initiates step 312 when a particular condition is met. For instance, the survey collection component monitors the webpages visited by the website visitor, and triggers the display of the survey questionnaire as an overlay to the displayed webpage when an n^{th} webpage of the website is visited by the user during the web session.

From an implementation perspective, one may decide for one realization to generate two distinct components for the visit collection component (used at step 310) and the survey collection component (used at step 312), as described above. Alternatively, one may decide for another realization to integrate the two described components into a single component controlling both the environmental data collection (performed at step 310) and the survey data collection (performed at step 312).

The survey questionnaire may take the form of a series of questions pertaining to the original intent of the user in relation to the visit of the website, when activating the originating channel (e.g. activating a hyperlink to the website) that led to the visit of the website. The series of questions may also pertain to the level of correlation of the website (or more specifically of products or services featured on the website) with the original intent of the website visitor. The responses to the survey questionnaire may be provided in the form of ratings, in a free-text form, and in a mix of both; as is well known in the art of web surveys. Use of ratings for at least part of the survey responses allows a more accurate quantitative analysis of the responses by the survey server 40. The survey questionnaire may comprise additional questions, for instance on the general intent of the user for visiting the website (e.g. purchase, comparison, support, etc.).

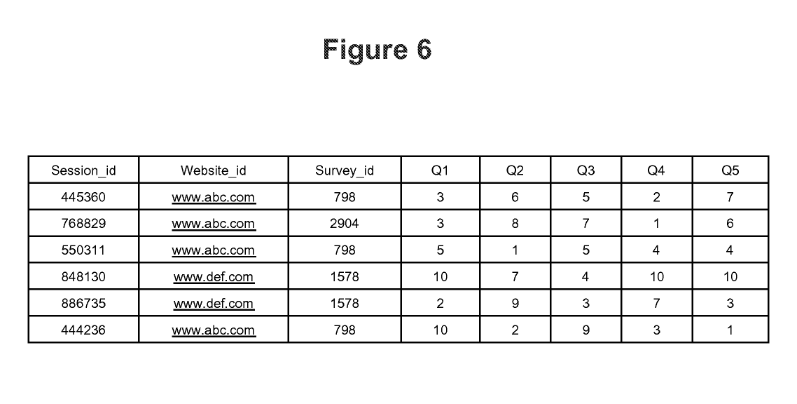

FIG. 6 illustrates an example of a table which can be generated and stored by the survey server 40, based on the data transmitted by the survey collection component at step 312. This table is for illustration purposes only, and is not intended to limit the type of data collected and transmitted by the survey collection component. The table contains the aforementioned web session identifier (Session_id). The table contains the aforementioned identifier of the visited website (Website_id), which generally consists in the URL of the visited website. The table contains an identifier of the survey (Survey_id), which can be a unique number generated by the survey server 40. The table further comprises answers to the questions (Q1, Q2, Q3, Q4 and Q5) of the survey, which are represented in the form of ratings in FIG. 6, but may also include text.

An example of question of the survey for which an answer by the visitor of the website is recorded in the table illustrated in FIG. 6 includes the search keyword(s) entered by the website visitor during a search query (the originating channel) that led to the visit of the website. Another example of question of the survey includes the primary purpose of visit of the website visitor (what was the main goal of the visitor for visiting the website, including for example: shopping, browsing, price learning, purchasing, managing an account, accessing support, etc.).

Based on the particular questions of a particular survey, step 312 may take place at a particular time of the website visit, or may be spread over a broader period of the website visit (e.g. the survey questionnaire is provided in a single phase or in multiple phases during the website visit). Furthermore, the transmission by the survey collection component of the survey participation data (comprising the collected answers to the survey questions) to the survey server 40 may occur either in a single step at the end of the survey process, or in several steps along the collection of the responses to the survey questions.

The survey collection component is running from the time the associated embedded script is processed at step 308, to the time when the survey process is completed (all the answers to the survey questionnaire have been provided by the website visitor). Alternatively, if the session during which the website visit takes place ends (e.g. if the website visitor closes the web client component or the window(s) or tab(s) associated to the website webpage are closed), then the survey collection component stops running. Thus, in a standard mode of operation, the website visitor accesses and views a series of webpages of the visited website. Throughout the visit of these webpages, the visit collection component and the survey collection component are running in the background until their mutual tasks (respectively steps 310 and 312) are completed.

The visit collection component operates without human interactions to collect and transmit to the survey server 40 a web session identifier and data collected regarding the originating channel that led to the website visit. The survey collection component presents a survey questionnaire to the website visitor, collects responses to the survey questionnaire, and transmits to the survey server 40 the web session identifier and survey participation data based on the collected responses.

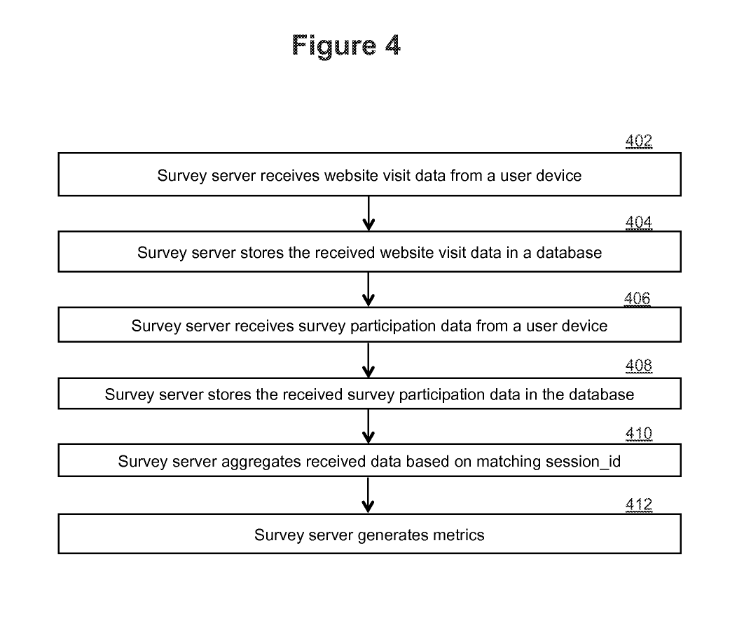

Reference is now made concurrently to FIGS. 1, 2a, 2b and 4, where FIG. 4 illustrates steps performed on the survey server 40 for correlating originating channels of a website visit with corresponding survey participation data.

As illustrated in FIG. 1, the survey server 40 comprises a communication interface for communicating over a communication network (e.g. the Internet 10) with user devices 20, memory, and a processing unit. The processing unit may comprise one or several processors, each processor including one or several cores. The memory stores software instructions executed by the processing unit, data generated by the processing unit, data received via the communication interface, etc.

At step 402, the survey server 40 receives from the user device 20 website visit data (collected at step 310 of FIG. 3). As mentioned previously, the website visit data include a web session identifier, a website identifier (e.g. URL of the website), and originating channel information.

At step 404, the survey server 40 stores the received website visit data in a database.

At step 406, the survey server 40 receives from the user device 20 survey participation data (collected at step 312 of FIG. 3). As mentioned previously, the survey participation data also include the web session identifier.

A step 408, the survey server 40 stores the received survey participation data in the database.

The survey server 40 receives website visit data at step 402 and survey participation data at step 406 from a plurality of user devices 20 visiting the website. The received data are stored in the database at steps 404 and 408, until a sufficient amount of data has been received for performing a relevant analysis at steps 410 and 412. It may take minutes, hours, days, weeks, until a sufficient amount of data is collected, based on the traffic on the website. The storage of the received data in the database is for illustration purposes only. Other means for storing the received data may be implemented at the survey server 40.

At step 410, the survey server 40 aggregates the received website visit data and the received survey participation data stored in the database, based on a matching web session identifier. The web session identifier allows the survey server 40 to match website visit data received from a particular user device 20 visiting the website to corresponding survey participation data from the same particular user device 20 visiting the website. Since the website visit data can be received independently of the survey participation data, the same unique web session identifier is used for the two types of received data for each particular user device 20 visiting the website. Alternatively, if the website visit data and the survey participation data are transmitted together by the user device 20 to the survey server 40, a common unique web session identifier is not needed for matching these data, and step 410 is not performed.

At step 412, the survey server 40 generates metrics based on the analysis of the matched website visit data and survey participation data received with respect to the visits of the website by a plurality of user devices 20.

As mentioned previously, the survey participation data may comprise ratings voluntarily provided by website visitors. Alternatively or complementarily, the survey participation data comprise free-text responses from website visitors, which can be analyzed by the survey server 40 to generate corresponding ratings. At least some of the ratings may be presentative of a user intent for visiting the website (e.g. the user intent is 20% browsing, 20% price learning, 80% purchasing, 0% managing an account, 0% accessing support, etc.). Thus, an example of metrics generated at step 412 includes metrics which indicate a level of correlation between the user intent for visiting the website, and the different originating channels (recorded in the website visit data) which led to the visit of the website. The metrics illustrate which originating channel(s) are highly correlated to a purchase user intent, to a browsing user intent, etc.

Alternatively or complementarily, at least some of the ratings may be presentative of a user experience when visiting the website (e.g. very satisfied, satisfied, neutral, not satisfied, very unsatisfied, etc.). Thus, an example of metrics generated at step 412 includes metrics which indicate a level of correlation between the user experience when visiting the website, and the different originating channels (recorded in the website visit data) which led to the visit of the website

Furthermore, the generated metrics can be represented visually. For instance, a Keyword Intent Spectrum graph can be generated, wherein a list of keywords (e.g. search keywords provided when the originating channel is a search engine) are analyzed in relation with a particular user intent. A level of correlation of each of the keywords in relation with the particular user intent for the website visit is determined, according to an entropy computing process. The process can be repeated for various user intents (e.g. visit, purchase, support, etc.) in relation to the list of keywords. A list of keywords (collected at step 310 of FIG. 3 and received at step 402 of FIG. 4) is provided. Each keyword is associated with a selected user intent (e.g. purchase) and an Information Gain score. The Information Gain score is a value computed based on an Entropy principle. The higher the Information Gain score associated with a particular keyword, the higher the level of correlation between the particular keyword and the selected user intent. The lower the Information Gain score associated with a particular keyword, the less statistically significant the association of the particular keyword with the selected user intent. The Keyword Intent Spectrum graph visually represents the level of correlation between the various keywords and the selected user intent. Several user intents can be selected, and several corresponding Keyword Intent Spectrum graphs generated.

Additional parameters may be taken into consideration for generating the metrics. These additional parameters complement the survey participation data and the originating channel data, which are used for generating the metrics as described previously. The additional parameters can be collected at step 310 of FIG. 3.

For instance, the metrics may be generated independently for three categories of user devices 20: desktop and laptop computers, tablets, and smartphones. These independent metrics further illustrate the influence of the type of user device 20. For example, the independent metrics illustrate the influence of the type of user device 20 on the correlation between a specific user intent and a plurality of search keywords (e.g. search keywords provided when the originating channel is a search engine).

The metrics generated at step 412 of FIG. 4 are either directly provided to a website representative, or made available to the website representative through a secure communication channel wherein the website representative can access the metrics at his discretion. In the latter case, the metrics may also be interactive metrics, wherein the website representative can modify a configuration to change the displayed metrics (e.g. by filtering the displayed metrics based on a particular user intent for visiting the website).

Different languages and formats can be used to transmit the website visit data and the survey participation data from the user devices 20 to the survey server 40. For instance, a more or less structured data format can be used. In one realization, the survey participation data are transmitted using a text file format. In another realization, the survey participation data are transmitted using the Extensible Markup Language (XML) format. In still another realization, the Triple-S file format is used to transmit the survey participation data.

Although the present disclosure has been described hereinabove by way of non-restrictive, illustrative embodiments thereof, these embodiments may be modified at will within the scope of the appended claims without departing from the spirit and nature of the present disclosure.

What is claimed is:

1. A survey server comprising:
a processing unit;
a communication interface for exchanging data with a plurality of user devices; and
memory for storing:
website visit data and survey participation data; and
code responsible when executed by the processing unit for:
collecting the website visit data from the plurality of user devices, the website visit data comprising for each specific user device an originating channel that led to a visit of the website by a user of the specific user device;
collecting the survey participation data from some of the plurality of user devices, the survey participation data corresponding to survey information received from the users of the user devices in relation to the visit of the website; and
analyzing the website visit data and the survey participation data to generate metrics correlating the originating channels of the website visit data with the survey participation data.

2. The survey server of claim 1, wherein the originating channel comprises at least one of the following: a direct access to the visited website, a hyperlink in a referrer website leading to the visited website, and a search result leading to the visited website.

3. The survey server of claim 1, wherein the website visit data and the survey participation data comprise a web session identifier for uniquely identifying a particular visit of the website by a particular user device, and analyzing the website visit data and the survey participation data comprises matching the website visit data and the survey participation data based on the web session identifier.

4. The survey server of claim 1, wherein the survey participation data comprise an intent of the user for visiting the website, and the generated metrics consist of metrics correlating the originating channels of the website visit data with the user intents of the survey participation data.

5. The survey server of claim 1, wherein the survey participation data comprise an experience of the user when visiting the website, and the generated metrics consist of metrics correlating the originating channels of the website visit data with the user experience of the survey participation data.

6. The survey server of claim 1, wherein the generation of the metrics correlating the originating channels of the website visit data with the survey participation data further takes into consideration complementary information related to the originating channels, the complementary information being comprised in the website visit data.

7. The survey server of claim 6, wherein the originating channel consists of a hyperlink in a referrer website leading to the visited website, and the complementary information comprises an URL of the referrer website.

8. The survey server of claim 6, wherein the originating channel consists of a search result leading to the visited website, and the complementary information comprises search keywords.

9. The survey server of claim 8, wherein the generated metrics consist of metrics correlating the search keywords with the survey participation data.

10. A method for correlating originating channels of a website visit with corresponding survey participation data, comprising:
collecting at a survey server website visit data from a plurality of user devices, the website visit data comprising for each specific user device an originating channel that led to a visit of the website by a user of the specific user device;
collecting at the survey server survey participation data from some of the plurality of user devices, the survey participation data corresponding to survey information received from the users of the user devices in relation to the visit of the website; and
analyzing by the survey server the website visit data and the survey participation data to generate metrics correlating the originating channels of the website visit data with the survey participation data.

11. The method of claim 10, wherein the originating channel comprises at least one of the following: a direct access to the visited website, a hyperlink in a referrer website leading to the visited website, and a search result leading to the visited website.

12. The method of claim 10, wherein the website visit data and the survey participation data comprise a web session identifier for uniquely identifying a particular visit of the website by a particular user device, and analyzing the website visit data and the survey participation data comprises matching the website visit data and the survey participation data based on the web session identifier.

13. The method of claim 10, wherein the survey participation data comprise an intent of the user for visiting the website, and the generated metrics consist of metrics correlating the originating channels of the website visit data with the user intents of the survey participation data.

14. The method of claim 13, wherein the intent of the user for visiting the website comprises at least one of the following: browsing, price learning, purchase, account management, and support.

15. The method of claim 10, wherein the survey participation data comprise an experience of the user when visiting the website, and the generated metrics consist of metrics correlating the originating channels of the website visit data with the user experience of the survey participation data.

16. The method of claim 10, wherein the generation of the metrics correlating the originating channels of the website visit data with the survey participation data further takes into consideration complementary information related to the originating channels, the complementary information being comprised in the website visit data.

17. The method of claim 16, wherein the originating channel consists of a hyperlink in a referrer website leading to the visited website, and the complementary information comprises an URL of the referrer website.

18. The method of claim 16, wherein the originating channel consists of a search result leading to the visited website, and the complementary information comprises search keywords.

19. The method of claim 18, wherein the generated metrics consist of metrics correlating the search keywords with the survey participation data.

20. The method of claim 10, wherein the generation of the metrics correlating the originating channels of the website visit data with the survey participation data further takes into consideration a type of the user device, the type of the user device being comprised in the website visit data.
